(19) United States
(12) Patent Application Publication
(10) Pub. No.: US 2013/0004689 A1
(43) Pub. Date: Jan. 3, 2013

(54) Method of Forming a Blowable Parison

(75) Inventors: Giuseppe Di Bono, Mira (IT); Nicola Pretto, Mira (IT)

(73) Assignee: Reckitt Benckiser N.V., WT Hoofddorp (NL)

(21) Appl. No.: 13/390,975

(22) PCT Filed: Aug. 20, 2010
(86) PCT No.: PCT/GB2010/051386

§ 371 Date: Sep. 5, 2012

(30) Foreign Application Priority Data
Aug. 22, 2009 (GB) 0914702.6

(51) Int. Cl. B29C 45/16; B32B 1/02; B29C 49/22

(52) U.S. Cl. 428/35.7; 264/46.4; 264/513

(57) ABSTRACT

A method of forming an essentially tubular blowable plastics parison comprises injection moulding an essentially tubular parison around a mould surface. Means for injecting flowable plastics material to said injection mould at an injection station to form a parison within said mould surface are used. These comprise a plurality of individual injectors, with at least a secondary injector being capable of injecting a different composition from the remaining primary injectors.

This invention relates to the injection moulding of plastics articles, especially blowable plastics parisons.

Blow moulding of bottles from blowable parisons is well known. In the bottle forming process a pre-formed parison is formed by injecting a flowable plastics material into a mould. This parison is treated in a second stage by blowing the parison in a second mould (usually under heat application) to produce a finished container/bottle.

The process is flexible, quick and relatively inexpensive and is used in mass-production facilities for the production of bottles and containers for household articles. The articles can even be recycled after use in straightforward processes.

One issue for containers produced in this way is the incorporation therein of materials which generate pressure in storage. Of course in some cases, such as the containerisation of soft drinks, the build-up/maintenance of pressure is a desired feature and the container is designed to accommodate such pressure. In other cases where containers are intended to store non-edible compositions/toxic compositions the build-up of pressure is extremely undesirable as on opening of the container/removal of the container contents adverse pressure in the container can cause erratic/unpredictable content discharge. Such discharge can be harmful to a user.

Additionally some compositions cause excessive pressure build-up in a container which, if left unaddressed would cause rupture of the container and thus spillage.

Usually a pressure relief mechanism is incorporated into containers which are intended to accommodate a material which gives rise to gas evolution/pressure build up. Often the relief mechanism comprises a valve which is incorporated into the container.

Such a valve may be incorporated either in the container's lid or directly onto the container's cap. In each case, a significant drawback exists in the need for an extra manufacturing operation, including extra material, extra processing time and extra packaging equipment (and/or an additional supplier/manufacturer for producing the venting lids/applying the inserts).

It is an object of the present invention to obviate/mitigate the disadvantages of the prior art shown above.

According to a first aspect of the invention there is provided method of forming an essentially tubular blowable plastics parison comprising injection moulding an essentially tubular parison within a mould surface, using means for injecting flowable plastics material to said injection mould at an injection station to form a parison within said mould surface, wherein said means comprises a plurality of individual injectors, with at least a secondary injector being capable of injecting a different composition from the remaining primary injectors, the material being injected by the secondary injector being capable of forming a porous sector of the parison.

The method of the invention has been found to be surprisingly advantageous is that the production of blowable parison is facilitated wherein the parison comprises a portion comprising porous material. Thus the parison can be formed into a container which can be used to accommodate a material that generates pressure in storage, wherein the pressure can be released without causing rupture of the container/erratic container content discharge. Additionally no secondary pressure release mechanism is required. Moreover there is no need for any additional manufacture steps for the incorporation of such secondary pressure release mechanism.

The secondary material is a capable of forming a porous portion of material. Suitable examples of secondary materials include polyethylene, polypropylene or polyethylene terephthalate resins blended with open porosity generators.

Generally the open porosity generators comprise gases, low boiling temperature liquids or degradable substances that degrade (e.g. under the application of heat) to yield gaseous by-products (such as hydrogen, oxygen, nitrogen, carbon dioxide, carbon monoxide and/or water vapour. Suitable examples of open porosity generators include acetone, sodium bicarbonate, azodicarbonamide, p-toluene sulfonyl semicarbazide, and p,p-oxybis benzene sulfonyl hydrazide.

Preferably the primary material is a capable of forming a non-porous skin of material. Suitable examples of primary materials include plastics material such as polyethylene, polypropylene or polyethylene terephthalate.

After injection the parison may require/be subjected to further processing steps. A preferred example of such a step is a curing step. In such a step no additional treatment may be applied to the parison but the parison may be allowed to “rest” for a period of time (possibly under altered temperature/altered humidity) so that all of its components are allowed to fully stabilise and/or to allow the porosity generation step to come to completion.

Preferably the parison of the first aspect of the invention is further processed into a container for accommodating an amount of material, preferably a liquid material but optionally a solid material/admixture of liquid and solid material, e.g. such as paste.

Thus according to a second aspect of the invention there is provided a container comprising a parison according to the first aspect of the invention, wherein the container is formed by the application of internal pressure and/or heat to the parison in a mould.

Generally the container is formed such that it has a closure, e.g. a screw-top lid which co-operates with an engaging screw-thread and other optional features such as a handle.

Preferably the container is for a liquid containing a material that evolves a gas.

Suitable examples of gas evolving material comprise bleaches, e.g. per-salts (such as percarbonate, perborate, a peracid and/or a salt thereof), hydrogen peroxide, chlorine based compound.

Preferably the bleach forms a part of a detergent formulation. The detergent formulation is preferably in the form of a liquid. The detergent formulation may comprise one or more other components that are typically found in a detergent formulation such as a surfactant (nonionic, cationic, anionic), enzyme, pH modifying agent, dye, perfume, builder, dye transfer inhibition agent, thickener, stabiliser, soil suspending agent.

The container may comprise multiple compartments (either formed from a single parison or from multiple joined parisons). Preferably 2, 3, 4 or more compartments may be present. The compartments may be arranged in a side by side format. Each compartment may have its own release opening or there may be a common opening for some or all of the compartments. The compartments may be used to house different formulations. The different formulations may be antagonistic toward one another, e.g. a bleach based formulation and an enzyme based formulation. At least one (or all) the different formulations may release a gas in storage.

1. A method of forming an essentially tubular blowable plastics parison comprising the steps of:
injection moulding an essentially tubular parison around a mould surface, using means for injecting flowable plastics material to said injection mould at an injection station to form a parison around said mould surface, wherein said means comprises a plurality of individual injectors, with at least a secondary injector adapted to inject a different composition from the remaining primary injectors.

2. A method according to claim 1, wherein the secondary material is adapted to form a porous portion of material.

3. A method according to claim 1, wherein the secondary material is a plastics material.

4. A method according to claim 1, wherein the secondary material includes an open porosity generator.

5. A method according to claim 4, wherein the open porosity generator comprises a gas, a low boiling temperature liquid or a degradable substance.

6. A method according to claim 1, wherein the primary material forms a non-porous skin of material.

7. A method according to claim 6, wherein the primary material is a plastics material.

8. A container comprising a parison wherein the parison is formed by injection moulding an essentially tubular parison around a mould surface, using means for injecting flowable plastics material to said injection mould at an injection station to form a parison around said mould surface, wherein said means comprises a plurality of individual injectors, with at least a secondary injector adapted to inject a different composition from the remaining primary injectors, and wherein the container is formed by the application of internal pressure or heat, or both an internal pressure and heat to the parison in a mould.

9. A container according to claim 8, wherein the container is for a liquid containing a material that evolves a gas.

10. A container according to claim 9, wherein the gas evolving material is a bleach.

11. A method according to claim 3 wherein the plastics material is one or more of polyethylene, polypropylene or polyethylene terephthalate.

12. A method according to claim 5 wherein the open porosity generator present is a degradable substance selected from: acetone, sodium bicarbonate, azodicarbonamide, p-toluene sulfonyl semicarbazide, and p,p-oxybis benzene sulfonyl hydrazide.

13. A method according to claim 7 wherein the primary material is a plastics is one or more of polyethylene, polypropylene or polyethylene terephthalate.

14. A container according to claim 9, wherein the bleach is a per-salt, hydrogen peroxide, or chlorine based compound
